(19) United States
(12) Patent Application Publication
(10) Pub. No.: US 2009/0138718 A1
(43) Pub. Date: May 28, 2009

(54) Method of generating a signature with "tight" security proof, associated verification method and signature scheme based on the diffie-hellman model

(75) Inventor: Benoit Chevallier-Mames, Cassis (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 11/667,062

(22) PCT Filed: Oct. 18, 2005
(86) PCT No.: PCT/EP05/55347

§ 371 Date: May 4, 2007

(51) Int. Cl. H04L 9/32; H04L 9/30

(52) U.S. Cl. 713/176; 380/30

(57) ABSTRACT

The invention relates to a method of electronically signing a message m, characterized in that it uses: p a prime integer, q a prime integer divider of (p−1), g, an element of order q of the set Zₚ of integers modulo p, H and G, hash functions, x a private key and y, for example y=ĝx mod p, a public key of the set Zₚ, to carry out the following steps, consisting in: E1: generating k, a random number k of the set Z_{q} of integers modulo q, and calculating u=g^{k} mod p, h=H(u), z=h^{x} mod p and v=h^{k} mod p, E2: calculating c=G (m, g, h, y, z, u, v) and s=k+c.x mod q, and E3: producing an electronic signature of the message m equal to (z, s, c). The invention also relates to a verification method and a signature scheme associated with the signature method.

The invention relates to proven secure digital signatures, based on the Diffie-Hellman problem. The invention also relates to verification methods and associated signature schemes. Some methods according to the invention can be implemented “on the fly”, which enables the rapid generation of a digital signature once certain pre-calculations have been made. This makes the invention particularly useful in the context of portable objects with low computational power such as a chip card.

A digital signature of a message is one or more numbers dependent on both a secret key known only to the person signing the message, and the contents of the message to be signed. A digital signature must be verifiable: it must be possible for a third party to verify the validity of the signature, without requiring knowledge of the secret key of the person signing the message.

A signature scheme comprises a group of three methods (GEN_S, SIGN_S, VER_S):
GEN_S is a method of generating public and private keys.
SIGN_S is a method of generating a signature
VER_S is a method of verifying a signature.

There are numerous digital signature schemes. The best-known ones are:
The RSA signature scheme: this is the most commonly used digital signature scheme. Its security is based on the difficulty of factoring large numbers.
The Rabin signature scheme: its security is also based on the difficulty of factoring large numbers.
The El-Gamal type signature scheme: its security is based on the difficulty of the discrete logarithm problem. The discrete logarithm problem involves determining the existence of an integer x such that y=g^{x}, where y and g are two elements of a set E having a group structure.
The Schnorr signature scheme: this is a variation of the El-Gamal type signature scheme. (Claus-Peter Schnorr, Efficient signature generation by smart cards, Journal of Cryptology, 4(3):161-174, 1991),
The Girault-Poupard-Stern signature scheme (Marc Girault: An identity-based identification scheme based on discrete logarithms modulo a composite number, EUROCRYPT'90, vol. 473 of Lecture Notes in Computer Science, pages 481-486; and Guillaume Poupard and Jacques Stern, Security analysis of a practical “on the fly” authentication and signature generation, EUROCRYPT'98, vol. 1403 of Lecture notes in Computer Science, pages 422-436, 1998)
the Poupard-Stern signature scheme (Guillaume Poupard and Jacques Stern, On the fly signatures based on factoring, ACM Conference on Computer and Communications Security, pages 37-45, 1999).

A signature scheme is said to be “proven secure” if it can, by a mathematical proof, use a potential attacker against the signature scheme (more specifically, if forged signatures, which is to say forged by this attacker, can be used) to solve a difficult problem, such as discrete logarithm or factorisation.

Some security proofs are determined by the so-called “random oracle model”.

The random oracle model is an ideal model in which any hash function is considered to be completely random. As a hash function is not a completely random function in practice, a proof in the random oracle model is generally considered to be an indication that the scheme is constructed properly, but does not offer a complete guarantee of the security of the scheme in its practical application.

Conversely, a cryptographic scheme is said to be proven secure in the standard model when its security can be proven without speculating on the completely random nature of the hash functions. Such a security proof is particularly useful as it ensures complete confidence in the security of the scheme in its practical application.

The proofs can be tight reductions or loose reductions. A loose reduction uses an attacker and solves the difficult problem with low probability compared to that of the attacker. Conversely, a tight reduction solves the problem with probability very near to that of the attacker. Thus, a tight proof is a better security guarantee for a signature scheme.

Schemes with tight proven security are evidently preferable to schemes with loose proven security. However, in practice very few schemes have a tight security proof. For example, the RSA-PSS scheme and its derivatives based on the RSA problem are known (Ronald L. Rivest, Adi Shamir and Leonard M. Adleman, A method for obtaining digital signatures and public-key cryptosystems, Communications of the ACM, 21(2):120-126, 1978), or even the Rabin-PSS scheme based on the factorisation problem (Michael O. Rabin, Digital signatures and public-key functions as intractable as factorization, Tech. Rep. MIT/LCS/TR-212, MIT Laboratory for Computer Science, 1979). For a long time no schemes based on the Diffie-Hellman problem or the discrete logarithm problem and having a tight security proof were known, only schemes with loose security proof (David Pointcheval and Jacques Stern, Security proofs for signature schemes, in U. Maurer, editor, Advances in cryptology, EUROCRYPT'96, vol. 1070 of Lectures Notes in Computer Sciences, pages 387-398, Springer-Verlag, 1996).

Goh and Jarecki have suggested using a scheme based on the Diffie-Hellman problem, known as the EDL (Equivalent Discrete Algorithm) scheme, and recently proved that this scheme has a tight security proof in the random oracle model (Eurocrypt 2003, Ed. E. Biham, LNCS 2656, pp 401-415, 2003).

The EDL scheme comprises the key generation algorithm, the signature method and the verification method described above.

That is:
p, a prime integer of ∥p∥ bits, (the ∥p∥ notation means “number of bits of the binary number p”)
q, a prime integer of ∥q∥ bits which is a divisor of (p−1),
g, an element g of the order q of the set Zₚ of modulo p integers,
G_{g,p} a finite group generated by g.
M, the set of all messages
H, G, two hash functions such that H: M×{0,1}^{∥r∥}−>G_{g,p} and G: (G_{g,p})⁶−>Z_{q}.

The key generation method involves generating a random number xεZ_{q}, then calculating y=g^{x} mod p. y is the public key and x is the private key

The signature method makes it possible to sign a message m εM. For this purpose, a random integer r of ∥r∥bits and a random number k εZ_{q} are generated, u=g^{k} mod p, h=H(m, r), z=h^{x} mod p, v=h^{k} mod p, then c=G(g, h, y, z, u, v) and s=k+c.x mod q are calculated. The signature of m is then the quadruple (z, r, s, c).

The verification method verifies that a signature (z, r, s, c) is indeed the signature of a message mεM. h′=H(m, r), u′=g^{s}·y^{-c} mod p and v′=h^{′s}·z^{-c} mod p are calculated. The signature is accepted if c=G(g, h′, y, z, u′, v′).

The EDL signature scheme supplies a signature of ∥P∥+2∥q∥+∥r∥ bits, which is a bit long but still acceptable for such a security level. Goh and Jarecki have shown that ∥r∥=111 can be used while still having a comfortable level of security.

A signature scheme is said to be “on the fly” when the signature generation can be split into two distinct phases: a first so-called precalculation phase, during which a datum (known as a coupon) independent of the message to be signed is precalculated, and the signature generation phase proper, during which a signature of a message m is calculated using the precalculated coupon, this latter phase being rapidly executable. In order to guarantee the security of the signature scheme, the same coupon can only be used once.

“On the fly” signature schemes are therefore particularly useful in the context of portable objects with low computational power such as chip cards. Such schemes enable quick signature generation by the portable object, while this is not possible using a standard signature scheme requiring much greater computational power.

In the publication “Improved online/offline signature schemes” by Shamir and Tauman (Proceedings of Crypto 01), the authors describe generic conversion means for obtaining an “on the fly” signature scheme from any signature scheme. The advantage of this conversion is that it preserves the security of the signature scheme: if the initial scheme has a security proof in the standard model, then the “on the fly” signature scheme obtained also has a security proof in the standard model.

The EDL scheme, in its initial version, is not intended for “on the fly” implementation using coupons. However, the above conversion method can be used on the EDL scheme so as to obtain an “on the fly” signature scheme having a tight signature proof in the random oracle model. And yet, the drawback of the conversion method is that it doubles the size of the public key as well as the size of the signature, and that it also increases the signature verification time. The total signature generation time (precalculation+generation) is itself increased.

However, Goh and Jarecki have indicated that it is possible to use the conversion method with a particular hash function, known as a chameleon hash function (H(m, r)=gmyr mod p) to transform the EDL scheme into a coupon scheme (Hugo Krawczyk and Tal Rabin, Chameleon Signatures, In Symposium on Network and Distributed System security—NDSS'00, pages 143-154, Internet Society, 2000, and also the publication “Improved online/offline signature schemes” by Shamir and Tauman (Proceedings of Crypto 01). Thus, forging a new signature is as complex as forging a new signature from the initial EDL scheme, or finding a collision in the chameleon hash function (which is to say to find two different numbers a, b such that H(a)=H(b))

The advantage of the obtained scheme is, evidently, the fact that the scheme works on the fly and can be implemented with limited hardware means. However, the drawback is a longer associated verification method, as it is necessary to calculate the chameleon hash function. Furthermore, using the chameleon hash function implies using a random number r of ∥q∥ bits. The obtained signature thus becomes ∥p∥+3∥q∥ bits in length. For cryptographic security reasons, q must be chosen with a size greater than 160 bits, and the signature obtained is therefore longer than a traditional EDL signature.

The invention aims to provide new signature methods based on the Diffie-Hellman problem, as secure as the EDL signature method (which is to say having a tight security proof), but which produce shorter signatures than the EDL method. Furthermore, certain methods according to the invention can be implemented “on the fly” using coupons, which is much faster than the EDL method. The invention also provides a verification method and associated signature scheme for each signature method according to the invention.

A method according to the invention implements a set of parameters, in particular:
p, a prime integer of ∥p∥ bits,
q, a prime integer of ∥q∥ bits which is a divisor of (p−1),
g, an element of the order q of the set Zp of modulo p integers,
G_{g,p}, the finite group generated by g
H, G, hash functions,
x, a private key chosen randomly from Zₚ, and y an associated public key. y is, for example, calculated from the relation y=ĝx mod p (the notation ĝx or g^{x} means modular exponentiation).

The method of digitally signing a message m according to the invention comprises the following steps, involving:
E1: generating k, a random number from the set Z_{q} of modulo q integers, and calculating u=g^{k} mod p, h=H(u), z=h^{x} mod p and v=h^{k} mod p,

E2: calculating c=G(m, 9, h, y, z, u, v) and s=k+c.x mod q, and
E3: producing a digital signature of the message m equal to (z, s, c).

The produced signature (z, s, c) comprises only three numbers z, s, and c and is equal in size to ∥p∥+2∥q∥, shorter than a signature obtained from an EDL scheme using ∥r∥=111 bits.

In a first implementation:
during an initialisation phase, the step E1 is carried out one or more times and a coupon (k, u, v, h, z) is stored at the end of each step, then
steps E2 and E3 are then carried out for each message m to be signed using a coupon (k, u, v, h, z) stored during the initialisation step.

In a second implementation:
during an initialisation phase, step E1 is carried out one or more times and a coupon (k, u, v, z) is stored at the end of each step, then
steps E2 and E3 are then carried out for each message m to be signed using a coupon (k, u, v, z) stored during the initialisation step and recalculating h=H(u).

These two embodiments of the invention have the advantage of being conducted by coupons without it being necessary to use an additional chameleon hash function, which comprises multi-exponentiation and therefore takes a long time. This enables on the fly implementation which is particularly favourable for portable systems, and much more advantageous than an implementation of the EDL scheme which does use a chameleon hash function.

Furthermore, in the case of the invention, the two embodiments of the invention do not have any additional cost (in terms of material resources or computation time) for the person verifying the obtained signature, as he/she does not have to calculate a chameleon hash function based on an exponentiation.

Moreover, the second embodiment of the invention uses smaller stored coupons:
in the first embodiment of the invention, the coupons comprise five numbers, that is 4.∥p∥+∥q∥ bits in total, and
in the second embodiment of the invention, the coupons comprise four numbers, that is 3.∥p∥+∥q∥ bits in total.

On the other hand, in the second embodiment of the invention, the signature computation time is a little longer than in the first embodiment of the invention, as h must be recalculated.

In a third embodiment of the invention:
during step E1, t=I(g, h, y, z, u, v) is also calculated, where I is a hash function, then during step E2, c=G(m, t) is calculated instead of c=G(m, g, h, y, z, u, v).

And preferably:
during an initialisation phase, step E1 is carried out one or more times and a coupon (k, z, t) is stored at the end of each step, then
steps E2 and E3 are then carried out for each message m to be signed using a coupon (k, z, t) stored during the initialisation step.

This coupon is smaller again (only three numbers, or ∥p∥+∥q∥+∥t∥ bits in total), which makes it possible to store a large number of coupons, even in a system with low memory capacity.

Furthermore, this variation with a coupon has no cost for the person verifying the signature: there is no need to calculate a chameleon hash function based on multi-exponentiation.

Finally, in the “on the fly” variation of the three embodiments of the invention, the so-called “on-line” steps, which is to say steps E2, E3, carried out when a signature is required, comprise only the calculation of a hash function, an addition and a modular multiplication, which is equivalent to the most efficient signature methods (in terms of computation time) currently known, in particular the Schnorr, Girault-Poupard-Stern or Poupard-Stern methods.

It should be noted that, preferably, in all the methods implemented on the fly, a coupon stored during the initialisation step is used during steps E2 and E3 and not used again during the preceding steps E2 and E3. This is for security reasons, naturally.

In a fourth embodiment of the invention:
during step E1, h=H(m, u) is calculated instead of h=H(u), then,
during step E2, c=G(g, h, y, z, u, v) is calculated instead of c=G(m, g, h, y, z, u, v).

This fourth embodiment of the invention is, in practice, an improvement of the traditional EDL method, a little different from the other three embodiments. A signature is obtained which is ∥r∥ bits shorter than a signature obtained by a traditional EDL method. However, this embodiment of the invention cannot easily be implemented on the fly with no additional cost, unlike the first three embodiments.

The invention also relates to a method of verifying a digital signature (z, s, c) of a message m obtained by a signature method according to the invention as described above.

If the signature method is implemented according to the first or second embodiment, the associated verification method comprises the following steps, involving:
F1: calculating u′=g^{s}·y^{-c} mod p, h′=H(u′) and v′=h^{′s}·z^{-c} mod p, and
F2: accepting the signature if c=G(m, g, h′, y, z, u′, v′) or rejecting the signature otherwise.

If the signature method is implemented according to the third embodiment, the associated verification method comprises the following steps, involving:
F1: calculating u′=g^{s}·y^{-c} mod p, h′=H(u′), v′=h^{′s}·z^{-c} mod p and t′=I(g, h′, y, z, u′, v′),
F2: accepting the signature if c=G(m, t′) or rejecting the signature otherwise.

If the signature method is implemented according to the fourth embodiment, the associated verification method comprises the following steps, involving:
F1: calculating u′=g^{s}·y^{-c} mod p, h′=H(m, u′) and v′=h^{′s}·z^{-c} mod p, and
F2: accepting the signature if c=G(g, h′, y, z, u′, v′) or rejecting the signature otherwise.

Finally, the invention relates to a digital signature scheme with tight proven security in the random oracle model, during which the following is successively implemented:
a method of generating a public key y and a private key x such as used in the EDL scheme,
a signature method according to the invention as described above, and
an associated signature verification method according to the invention as described above.

All the signature methods according to the invention have tight proven security and are therefore at least as secure as the EDL signature method. The security proof of the methods according to the invention is similar to that developed for the EDL scheme in Eu-Jin Goh and Stanislaw Jarecki, A signature scheme as secure as the Diffie-Hellman problem. EUROCRYP'03, lecture notes in Computer science, pages 401-415, Springer Verlag, may 2003.

Finally, the invention relates to a portable electronic component comprising means for implementing a signature method and/or a verification method and/or a signature scheme according to the invention.

Such an electronic component is, for example, a chip card, or even a TPM (Trusted Platform Module) designed to be used in a standard unsecured PC computer.

1. Digital signature method for a message m, in which uses:
p, a prime integer,
q, a prime integer which is a divisor of (p−1),
g, an element of the order q of the set Zₚ of modulo p integers, H and G, hash functions,
x a private key and y, for example y=ĝx mod p, a public key from the set Zp,
herein said method comprises the following steps:
E1: generating a random number k from the set Z_{q} of modulo q integers, and calculating u=g^{k} mod p, h=H(u), z=h^{x} mod p and v=h^{k} mod p,
E2: calculating c=G(m, g, h, y, z, u, v) and s=k+c.x mod q, and
E3: producing a digital signature of the message m equal to (z, s, c).

2. Method according to claim 1, wherein:
during an initialisation phase, the step E1 is carried out one or more times and a coupon (k, u, v, h, z) is stored at the end of each step, and
steps E2 and E3 are then carried out for each message m to be signed using a coupon (k, u, v, h, z) stored during the initialisation phase.

3. Method according to claim 1, wherein:
during an initialisation phase, step E1 is carried out one or more times and a coupon (k, u, v, z) is stored at the end of each step, and
steps E2 and E3 are then carried out for each message m to be signed using a coupon (k, u, v, z) stored during the initialisation phase and recalculating h=H(u).

4. Method according to claim 1, also using a hash function 1, wherein:
during step E1, t=I(g, h, y, z, u, v) is also calculated, and,
during step E2, c is calculated as c=G(m, t).

5. Method according to claim 4, wherein:
during an initialisation phase, step E1 is carried out one or more times and a coupon (k, z, t) is stored at the end of each step, and
steps E2 and E3 are then carried out for each message m to be signed using a coupon (k, z, t) stored during the initialisation phase.

6. Method according to claim 2, wherein, during steps E2 or E3, a stored coupon is used during the initialisation stage and not used again during the preceding steps E2 and E3.

7. Method according to claim 1, wherein:
during step E1, h is calculated as h=H(m, u),
during step E2, c is calculated as c=G(g, h, y, z, u, v).

8. Method of verifying a digital signature (z, s, c) of a message m obtained by a signature method according to claims claim 1, comprising the following steps:
F1: calculating u′=g^{s}·y^{-c} mod p, h′=H(u′) and v′=h^{′s}·z^{-c} mod p, and
F2: accepting the signature if c=G(m, g, h′, y, z, u′, v′) or rejecting the signature otherwise.

9. Method of verifying a digital signature (z, s, c) of a message m obtained by a signature method according to claim 4, comprising the following steps:
F1: calculating u′=g^{s}·y^{-c} mod p, h′=H(u′), v′=h^{′s}·z^{-c} mod p and t′=I(g, h′, y, z, u′, v′),
F2: accepting the signature if c=G(m, t′) or rejecting the signature otherwise.

10. Method of verifying a digital signature (z, s, c) of a message m obtained by a signature method according to claim 7, comprising the following steps:
F1: calculating u′=g^{s}·y^{-c} mod p, h′=H(m, u′) and v′=h^{′s}·z^{-c} mod p, and
F2: accepting the signature if c=G(g, h′, y, z, u′, v′) or rejecting the signature otherwise.

11. (canceled)

12. Portable electronic component, comprising means for implementing a digital signature method for a message m, which uses:
p, a prime integer,
g, a prime integer which is a divisor of (p−1),
g, an element of the order q of the set Zₚ of modulo p integers,
H and G, hash functions,
x a private key and v, for example v=ĝx mod p, a public key from the set Zp, wherein said means executes the following steps:
generating a random number k from the set Z_{g} of modulo q integers, and calculating u=g^{k} mod p, h=H(u), z=h^{x} mod p and v=h^{k} mod p,
calculating c=G(m, g, h, V, z, u, v) and s=k+c.x mod q, and
producing a digital signature of the message m equal to (z, s, c).

13. Electronic component according to claim 12, wherein said electronic component is a chip card.

14. (canceled)

15. Method according to claim 3, wherein, during steps E2 or E3, a stored coupon is used during the initialisation stage and not used again during the preceding steps E2 and E3.

16. Method according to claim 5, wherein, during steps E2 or E3, a stored coupon is used during the initialisation stage and not used again during the preceding steps E2 and E3.
